(19) United States
(12) Patent Application Publication
(10) Pub. No.: US 2002/0152072 A1
(43) Pub. Date: Oct. 17, 2002

(54) Parametric encoder and method for encoding an audio or speech signal

(76) Inventor: Albertus Cornelis Den Brinker, Eindhoven (NL)

Correspondence Address: Michael E. Marion, c/o PHILIPS ELECTRONICS NORTH AMERICA CORPORATION, Intellectual Property Department, 580 White Plains Road, Tarrytown, NY, 10591, US

(21) Appl. No.: 10/046,632

(22) Filed: Jan. 14, 2002

(30) Foreign Application Priority Data
Jan. 16, 2001 (EP) 01200143.4
Jul. 17, 2001 (EP) 01202718.1

(51) Int. Cl. G10L 15/04

(52) U.S. Cl. 704/254

(57) ABSTRACT

The invention relates to a parametric encoder for encoding an audio or speech signal into sinusoidal code data. Such parametric encoders typically comprise a segmentation unit 120 for segmenting said signal s into at least one single scale segment xₘ(n) with m=1 . . . M and for outputting the samples xₘ(0), . . . ,xₘ(L−1) of said segment xₘ(n) and comprise a sinusoidal estimation unit 140 for estimating the sinusoidal code data representing said segment xₘ(n) from said samples. It is the object of the invention to improve a parametric encoder and method such that the achievement of a required time-frequency resolution trade-off is facilitated. This is achieved by embodying the segmentation unit 120 such that it carries out a frequency-warping operation in order to transform the output samples xₘ(0), . . . , xₘ(L−1) onto a frequency-warp domain and by providing a post-processing filter 160 for re-mapping the sinusoidal code data output by the sinusoidal estimation unit 140 to the original frequency domain of the signal s.

The invention relates to a parametric encoder and method for encoding an audio or speech signal into sinusoidal code data.

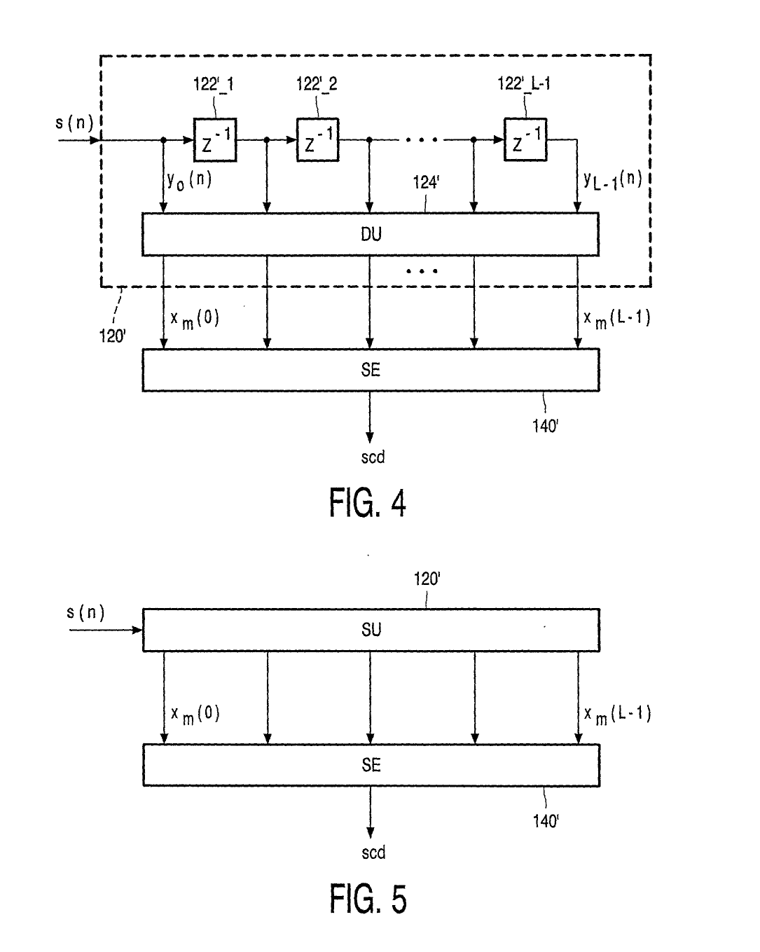

Such encoders and methods are generally known in the art and are for example disclosed in B. Edler, H. Purnhagen, and C. Ferekidis “ASAC—Analysis/synthesis codec for very low bit rates”, Preprint 4179 (F-6) 100^{th} AES Convention, Copenhagen, 11-14 May 1996. Such a known parametric encoder is illustrated in FIGS. 4 and 5.

According to FIG. 5 the encoder comprises a segmentation unit 120′ for segmenting a received audio or speech signal into at least one single scale segment xₘ(1) having the samples xₘ(0), . . . , xₘ(L−1). These samples are received by a sinusoidal estimation unit 140′, for estimating sinusoidal code data representing said segment xₘ(n). These sinusoidal code data are typically merged into a data stream before been transmitted via a channel or stored on a recording medium.

FIG. 4 provides an—also known—more detailed illustration of the segmentation unit 120′. As can be seen there, the audio or speech signal s(n) is input into a tapped delay line comprising consecutive filters 122_1′, 122_2′, . . . , 122_L−1′. The original audio or speech signal s(n)=y₀(nD) as well as the output signals y′₁(nD) . . . , y_{L-1}(nD) of said L−1 filters 122_1′, . . . 122_L−1′ are input into a sampling unit 124′, preferably embodied as down sampling unit, in order to generate L samples xₘ(0), . . . , xₘ(L−1) of the segment xₘ(1).

The single scale segments as generated by the known parametric encoder according to FIGS. 4 and 5 are characterised in that their segment length and consequently also their frequency resolution is constant independent of the actual frequency range of the segmented audio or speech signal. Expressed in other words, the single scale sinusoidal estimation mechanism as provide in the common encoders gives problems with the required time-frequency resolution trade-off. In particular for low frequency ranges of the signals for high-quality audio coding high frequency resolution is required, whereas for other frequency ranges a lower frequency resolution, i.e. a lower segment length L would be sufficient.

In order to overcome these problems, multi-scale models have been proposed, for example by T. S. Verma S. N. Levine and J. O. Smith III “Multiresolution sinusoidal modeling for wideband audio with modifications”, in Proc. ICASSP-98, Seattle, 1998. These multi-scale models provide different segment length L for different frequency ranges of the signal s. However, these multi-scale models bring about problems of scattering of components over scales and/or of merging the data retrieved at different scales. More specifically, a problem of scattering addresses the problem that the generated segments usually overlap and thus, samples of said segments might be processed twice because there is no clear separation possible—except of applying high effort—between the samples of two generated segments.

Starting from that prior art it is an object of the invention to improve a known parametric encoder and method for encoding an audio or speech signal such that a required time-frequency resolution trade-off can be established without having the above mentioned problems of the multi-scale models, namely the problem of scattering of components over scales and/or of merging the data retrieved at different scales.

This object is solved by the subject matter of claim 1. More specifically, for the known parametric encoder it is suggested according to claim 1, that the segmentation unit is further embodied for carrying out a frequency-warping operation in order to transform the output samples onto a frequency-warped domain and to provide a post-processing filter for re-mapping said sinusoidal code data output from the sinusoidal estimation unit to the original frequency domain of the signal s.

The segmentation unit of the claimed parametric encoder segments the signal s into at least one single scale segment xₘ(l). Because said unit only generates single scale segments the problems of the multi-scale models known in the art do not occur here. Instead, by applying the frequency-warping operation the required time-frequency resolution trade-off, i.e. providing different frequency resolutions for different frequency ranges of the signal s, can advantageously be established for single scale segments without any problems.

It shall be noted here that unilateral frequency-warping is generally known in the art, e.g. for linear predictive coding of audio, audio equalisation and by normal filter design, but not for sinusoidal coding as suggested in that application. Bilateral frequency warping has not been applied in audio processing.

Advantageous embodiments of that parametric encoder are mentioned in the dependent claims.

The object is further solved by a method for encoding an audio or speech signal according to claim 9. The advantages of said method correspond to the advantages mentioned above for the parametric encoder.

Five figures are accompanying the description, wherein

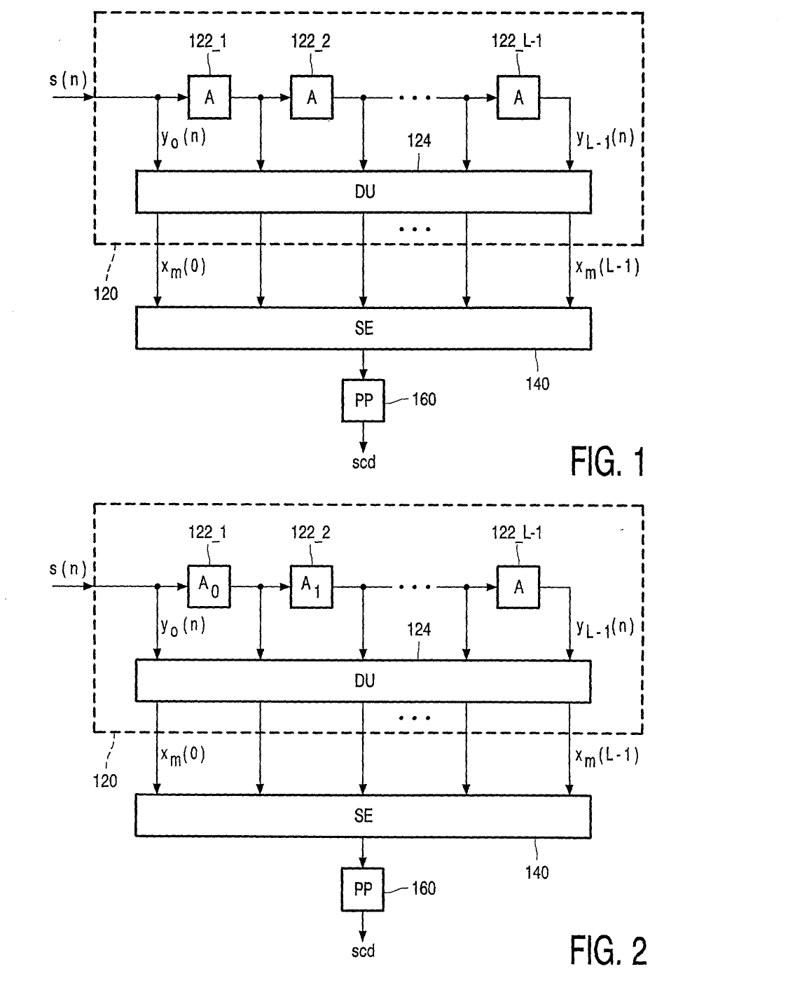

FIG. 1 shows a first preferred embodiment of the parametric encoder according to the invention;

FIG. 2 shows a second preferred embodiment of the parametric encoder according to the invention;

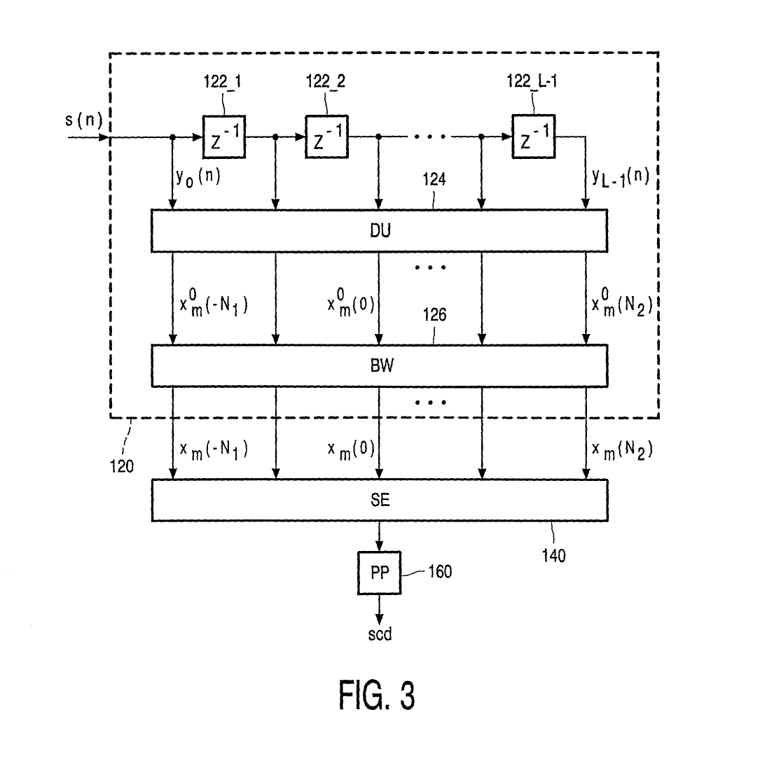

FIG. 3 shows a third preferred embodiment of the parametric encoder according to the invention;

FIG. 4 shows a detailed illustration of a parametric encoder known in the art; and

FIG. 5 shows a general block diagram of the parametric encoder known in the art.

In the following the preferred embodiments of the parametric encoder according to the invention are described by referring to FIGS. 1 to 3.

FIG. 1 shows a first preferred embodiment of the parametric encoder according to the invention for encoding an audio or speech signal s(n) into sinusoidal code data scd. It comprises a segmentation unit 120 for segmenting said signal s into at least one single scale segment xₘ(n) with m=1 . . . M, where m denotes a current downsampling step. More specifically, said segmentation unit 120 comprises a plurality of L−1 filters 122_1, . . . , 122_L−1 being connected in series for receiving the signal s(n) at the input of the first of said filters 122_1. Said segmentation unit 120 further comprises a sampling unit 124 for receiving and preferably down sampling said signal s(n)=y₀(n) as well as the output signals y₁(n). . . , y_{L-1}(n) of said L−1 filters 122_1, . . . , 122_L−1 in order to generate L samples xₘ(0), . . . , xₘ(L−1) of the single scale segment xₘ(1) with l=0 . . . (L−1). In said first embodiment all of the L−1 filters 122_1, . . . , 122_L−1 are embodied as all-pass filters having a transfer function A(z) defined as:

$$A ( z ) = \frac{- {λ}^{*} + {z}^{- 1}}{1 - λ {z}^{- 1}} , \qquad ( 1 )$$

where * denotes a complex-conjugation and |λ|<1. Typically, λ is real-valued and λ≠0.

In that first embodiment the processing is the following:

The audio signal s is input to a tapped all-pass line having outputs y₁(n) (l=0,1, . . . , L−1) with

y₀(n)=s(n),and (2)

yₗ=yₗ₋₁* α for l=1,2, . . . , L−1 (3)

with * denoting convolution and α the impulse response associated with the transfer function A(z). The outputs yₗ are downsampled (read-out every D time instances) and defined as a segment xₘ:

xₘ(l)=yₗ(mD) (4)

where D is the downsampling factor of the sampling unit 140. The signal output by said sampling unit 124 is considered to represent the samples xₘ(l) with l=0, 1, . . . , L−1 of a segment xₘ.

It is important to note that because the filters 122_1, . . . , 122_L−1 are—according to the first embodiment—embodied as all-pass filters the samples output by the sampling unit 124 are on a frequency-warped domain.

Said samples xₘ(l) with l=0, . . . , L−1 are input into a sinusoidal estimation unit 140 for estimating the sinusoidal code data representing the segment xₘ. The estimation may be done by carrying out a Fourier transformation on said frequency-warped samples and subsequent, for instance, peak picking.

It is further important to note that the sinusoidal code data as output by said sinusoidal estimation 140 is on a frequency-warped domain. Consequently, said sinusoidal code data has to be re-mapped, i.e. to be de-warped, to the original frequency domain of the audio or speech signal s. This is done by a post-processing filter 160 following said sinusoidal estimation unit 140. The output of said post-processing filter 160 corresponds to the re-mapped sinusoidal code data associated with the original signal segment xₘ.

After sinusoidal extraction, as finished by said post-processing filter 160, the subsequent processing step is residual modelling. The cheapest way of residual modelling is using a parametric model for the power spectral density functions. Such an approach allows the integration of sinusoidal and noise estimation since, for noise modelling frequency-warping can be used.

In the first embodiment the frequency warped samples warped by said sampling unit 120 belong to a single scale segment xₘ with the result that the problems of multi-scale models known in the art do not occur here. Due to the embodiment of the filters as all-pass filters a frequency-warping operation is carried out resulting in the frequency-warped samples at the output of the sampling unit 124. Due to the frequency warping operation the required time-frequency resolution trade-off is achieved for the signal s. However, disadvantageously, the power spectral density function of the original audio or speech signal is slightly amended.

FIG. 2 shows a second embodiment of the parametric encoder which substantially corresponds to the first embodiment. In particular, the sampling unit 124, the sinusoidal estimation unit 140 and the post-processing filter 160 in the second embodiment are identical to the corresponding units in the first embodiment. Moreover, the filters 122_3, . . . , 122_L−1 correspond to the respective filters in the first embodiment because they are also embodied as first-order all-pass filters having a transfer function A(z) according to equation (1).

However, the second embodiment differs from the first embodiment in that the first filter 122_1 in the series connection of filters in the segmentation unit 120 has a transfer function A₀(z) according to:

$${A}_{0} ( z ) = \frac{1}{1 - λ {z}^{- 1}} , \qquad ( 5 )$$

Moreover, the second filter 122_2 is also not embodied as all-pass filter but has instead a transfer function A₁(z) according to

$${A}_{1} ( z ) = \sqrt{1 - {\vert λ \vert}^{2}} \frac{{z}^{- 1}}{1 - λ {z}^{- 1}} , \qquad ( 6 )$$

wherein in equations 5 and 6 λ is typically real-valued.

For λ>0 the transfer functions A₀(z) and A₁(z) both represent a low-pass filter, whereas for λ<0 both transfer functions represent a high-pass filter.

The advantages of the second embodiment correspond to the first embodiment. Moreover, the shape of the power spectral density function of the original audio or speech signal s is better maintained.

A problem the first and second embodiment is that the introduced frequency warping operation acts as a unilateral device. The past is warped and, as a consequence of the fact that effectively the time-scale for each frequency is different, the estimated frequencies are good estimates for the instantaneous frequencies some n samples ago, where n, representing delays of the instantaneous frequencies, is dependent on the instantaneous frequencies themselves. Expressed in other words, the presence of the delay as such is accepted, but its frequency dependency should be avoided because this frequency dependency is disadvantageous for encoding purposes; for encoding purposes an estimate of the instantaneous frequencies at a well-defined moment in time is desired.

To achieve this, it is proposed to extend the frequency-warping procedure to a bi-lateral operation, warping both, the past and the future. The latter is not possible with the mechanisms considered in embodiments 1 and 2 since these are based on infinite-impulse response IIR-filters.

However, considering the frequency-warping of a finite segment and observing a finite part of the ideally infinitely-long warped signal then the processing using IIR-filters reduces to a matrix-vector multiplication. In that case the parametric encoder can be embodied according to a third embodiment of the invention as shown in FIG. 3. According to that embodiment the received audio or speech signal is input into a tapped delay line and subsequently said audio or speech signal s as well as the output signals y₁(n). . . , y_{L-1}(n) of the L−1 filters 122_1, . . . , 122_L−1 of the tapped delay line are input into a sampling 124 unit for generating a segment xₘ having a number of N₁+1+N₂ samples being indexed −N₁, −N₁+1, . . . , 0, . . . , N₂−1, N₂ with N₁, N₂>0. It is important to note that the sampling operation carried out so far in the third embodiment corresponds to the sampling operation known in the art as described by referring to FIG. 4 and that the samples resulting from that common sampling operation at the output of the sampling unit xₘ⁰(−N₁), . . . , xₘ⁰(0), . . . , xₘ⁰(N₂) are not yet on a frequency-warped domain.

In order to transform the samples onto the frequency-warped domain a bi-lateral warping operation is carried out by an additionally provided bi-lateral warping unit 126, preferably also provided within said sampling unit 120. Said unit carries out the matrix-vector multiplication mentioned in the previous paragraph, written in matrix notation:

xₘ=Bxₘ⁰ (7)

The transformation matrix B can be calculated for different frequency-warping operations, in particular it can be calculated such that the frequency-warping operations according to embodiment 1 or 2 of the invention are simulated or realised by the third embodiment. The samples output by said bi-lateral warping unit 126 are—in contrast to the input samples—on the desired frequency-warped domain like the samples output by the sampling unit 120 according to embodiments 1 or 2. As can be seen from FIG. 3 the transformed samples are output to the sinusoidal estimation unit 140 in which the desired sinusoidal code data are estimated and finally the sinusoidal code data on the frequency-warped domain is output by said estimation unit 140 and input into the post-processing filter 160 for being re-mapped to the original frequency domain of the signal s. Subsequently, an example for calculating the transformation matrix B is given such that embodiment 2 is simulated by embodiment 3.

In order to achieve this simulation, frequency-warping of a segment x⁰(n) having a finite support is considered. More specifically, the samples of said segment are indexed to −N₁, −N₁+1, . . . 0, . . . , N₂ with N₁, N₂>0. The associated warped signal is denoted by \tilde{x}(n) and has, in principle, an infinite support.

The Fourier transforms of the sample x(n) and of the associated warped signal are given as

$$S ( {ⅇ}^{j θ} ) = {\sum }_{n} x ( n ) {ⅇ}^{- j θ n}$$

$$\tilde{S} ( {ⅇ}^{j φ} ) = {\sum }_{n} \tilde{x} ( n ) {ⅇ}^{- j φ n}$$

with j=\sqrt{−1}. For frequency-warping according to the phase characteristic of an all-pass section the following relation between these frequency variables are given:

$$\begin{matrix}φ = θ + 2 arctan \{ \frac{λ sin θ}{1 - λ cos θ} \} , \\ or & ( 8 ) \\ {ⅇ}^{j θ} = \frac{{ⅇ}^{j φ} + λ}{1 + λ {ⅇ}^{j φ}} . & ( 9 )\end{matrix}$$

From this it follows that

$$\begin{matrix}\tilde{x} ( n ) = \frac{1}{2 π} {\int }_{< 2 π >} \tilde{S} ( {ⅇ}^{j φ} ) {ⅇ}^{j φ n} ⅆ φ \\ = \frac{1}{2 π} {\int }_{< 2 π >} S ( \frac{{ⅇ}^{j φ} + λ}{1 + {ⅇ}^{j φ} λ} ) {ⅇ}^{j φ n} ⅆ φ \\ = \frac{1}{2 π} {\int }_{< 2 π >} {\sum }_{k = ∞}^{∞} s ( k ) {( \frac{{ⅇ}^{j φ} + λ}{1 + {ⅇ}^{j φ} λ} )}^{- k} {ⅇ}^{j φ n} ⅆ φ \\ = {\sum }_{k = ∞}^{∞} x ( k ) \frac{1}{2 π} {\int }_{< 2 π >} {( \frac{{ⅇ}^{j φ} + λ}{1 + {ⅇ}^{j φ} λ} )}^{- k} {ⅇ}^{j φ n} ⅆ φ \\ = {\sum }_{k = ∞}^{∞} x ( k ) q ( λ ; n , k )\end{matrix} \qquad ( 10 )$$

with the definition of the interpolation function q

$$q ( λ ; n , k ) = \frac{1}{2 π} {\int }_{< 2 π >} {( \frac{{ⅇ}^{j φ} + λ}{1 + {ⅇ}^{j φ} λ} )}^{- k} {ⅇ}^{j φ n} ⅆ φ = {F}_{n}^{- 1} \{ {( \frac{{ⅇ}^{j θ} + λ}{1 + {ⅇ}^{j θ} λ} )}^{- k} \} \qquad ( 11 )$$

and Fₙ⁻¹ denoting the inverse Fourier transformation to the n-domain. More specifically,

q(λ;n,0)=δ(n);

q(λ;−,k)=impulse response of an kth order all-pass, k>0,

q(λ;n,k)=q(λ;−n,−k)

q(λ;n,k)=0, if n·k<0 or (k=0 and n≠0).

In matrix notation (omitting λ from the notation for this specific case) equation (7) can be written as:

$$( \begin{matrix}⋮ \\ {x}_{m} ( - n ) \\ ⋮ \\ {x}_{m} ( - 1 ) \\ x ( 0 ) \\ x ( 1 ) \\ ⋮ \\ {x}_{m} ( n ) \\ ⋮\end{matrix} ) = B \cdot ( \begin{matrix} \\ {x}_{m}^{0} ( - {N}_{1} ) \\ ⋮ \\ {x}_{m}^{0} ( - 1 ) \\ {x}_{m}^{0} ( 0 ) \\ {x}_{m}^{0} ( 1 ) \\ ⋮ \\ {x}_{m}^{0} ( {N}_{2} ) \\ \end{matrix} ) \\ ( \begin{matrix}⋮ \\ {x}_{m} ( - n ) \\ ⋮ \\ {x}_{m} ( - 1 ) \\ x ( 0 ) \\ x ( 1 ) \\ ⋮ \\ {x}_{m} ( n ) \\ ⋮\end{matrix} ) = ( \begin{matrix}⋮ & & ⋮ & & & & \\ q ( n , {N}_{1} ) & ⋯ & q ( n , 1 ) & & & & \\ ⋮ & & ⋮ & & & & \\ q ( 1 , {N}_{1} ) & ⋯ & q ( 1 , 1 ) & & & & \\ q ( 0 , {N}_{1} ) & ⋯ & q ( 0 , 1 ) & 1 & q ( 0 , 1 ) & ⋯ & q ( 0 , {N}_{2} ) \\ & & & & q ( 1 , 1 ) & ⋯ & q ( 1 , {N}_{2} ) \\ & & & & ⋮ & & ⋮ \\ & & & & q ( n , 1 ) & ⋯ & q ( n , {N}_{2} ) \\ & & & & ⋮ & & ⋮\end{matrix} ) ( \begin{matrix} \\ {x}_{m}^{0} ( - {N}_{1} ) \\ ⋮ \\ {x}_{m}^{0} ( - 1 ) \\ {x}_{m}^{0} ( 0 ) \\ {x}_{m}^{0} ( 1 ) \\ ⋮ \\ {x}_{m}^{0} ( {N}_{2} ) \\ \end{matrix} ) \qquad ( 12 )$$

i.e. column-wise the impulse responses of the cascaded all-pass filters appear. In practice, a truncated (windowed) warped signal \tilde{x} will be used for further processing. Assuming that the part of \tilde{x} shall consider ranges from −M₁ to M₂ and that M₁≈M₂>0 and N₁≈N₂. Then, approximately half of the matrix equals zero. For positive λ, the support of the truncated \tilde{x} will effectively be shorter than that of x.

The rows of the matrix correspond to the (truncated) impulse response of the filters described in embodiment 2.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A parametric encoder for encoding an audio or speech signal s into sinusoidal code data, comprising:
a segmentation unit (120) for segmenting said signal s into at least one single scale segment xₘ(n) with m=1 . . . M and for outputting the samples xₘ(0), . . . , xₘ(L−1) of said segment xₘ(n); and
a sinusoidal estimation unit (140) for estimating the sinusoidal code data representing said segment xₘ(n) from the received samples xₘ(0), . . . , xₘ(L−1)); characterized in that
the segmentation unit (120) is further embodied for carrying out a frequency-warping operation in order to transform the output samples xₘ(0), . . . , xₘ(L−1)) onto a frequency-warped domain; and
a post-processing filter (160) is provided for re-mapping said sinusoidal data output from the sinusoidal estimation unit (140) to the original frequency domain of the signal s.

2. The parametric encoder according to claim 1, characterized in that the segmentation unit (120) comprises
a plurality of L−1 filters (122_1, . . . 122_L−1) being connected in series for receiving the signal s(n) at the input of the first of said filters (122_1); and
a sampling unit (124) for receiving and sampling said signal s(n)=y₀(n) as well as the output signals
y₁(n) . . . y_{L-1}(n) of said L−1 filters (122_1, . . . 122_L−1) in order to generate L samples xₘ(0), . . . , xₘ(L−1) or xₘ⁰(0), . . . , xₘ⁰(L−1) of the segment xₘ.

3. The parametric encoder according to claim 2, characterized in that at least some of the filters (122_1, . . . 122_L−1) are embodied as all-pass filters.

4. The parametric encoder according to claim 3, characterized in that the some filters (122_1, . . . 122_L−1) are embodied as first-order all-pass filters each having a transfer function A(z) according to:
$$A ( z ) = \frac{- {λ}^{*} + {z}^{- 1}}{1 - λ {z}^{- 1}} ,$$
wherein λ* denotes a complex-conjugation and wherein λ is preferably real valued.

5. The parametric encoder according to claim 4, characterized in that all of the filters (122_1, . . . 122_L−1) out of the plurality of filters are embodied as first-order all-pass filter, each having a transfer function A(z) according to:
$$A ( z ) = \frac{- {λ}^{*} + {z}^{- 1}}{1 - λ {z}^{- 1}} ,$$
wherein λ* denotes a complex-conjugation and wherein λ is preferably real valued.

6. The parametric encoder according to claim 4, characterized in that the first filter (122_1) in said series connection receiving the signal s(n) has a transfer function A0(z) according to:
$${A}_{0} ( z ) = \frac{1}{1 - λ {z}^{- 1}} ,$$
the second filter (122_2) in said series connection following said first filter (122_1) has a transfer function A1(z) according to:
$${A}_{1} ( z ) = \sqrt{1 - \vert λ {\vert}^{2}} \frac{{z}^{- 1}}{1 - λ {z}^{- 1}} , and$$
the remaining filters (122_3 . . . 122_L−1) each are first order all-pass filters having a transfer function A(z) according to claim 4.

7. The parametric encoder according to claim 2, characterized in that
in the segmentation unit (120) the plurality of L−1 filters (122_1, . . . 122_L−1) being connected in series is embodied as tapped delay-line with each of the filters having a transfer function of A(z)=z⁻¹; and
there is additionally provided a bi-lateral warping unit (126) for transforming the samples on the original frequency-domain of the signal s x^{o}ₘ(−N₁), . . . , x^{o}ₘ(N₂) output by the sampling unit (124) into transformed samples xₘ(−M₁), . . . , x^{o}ₘ(M₂) on a frequency-warped domain by applying a bi-lateral frequency-warping operation to the samples x^{o}ₘ(−N₁), . . . , x^{o}ₘ(N₂) and for outputting the transformed samples xₘ(−M₁), . . . xₘ(M₂) to said sinusoidal estimation unit (140).

8. The parametric encoder according to claim 7, characterized in that the bi-lateral warping unit (126) carries out the transformation of the samples x^{o}ₘ into the samples xₘ according to:
$$( \begin{matrix}⋮ \\ {x}_{m} ( - n ) \\ ⋮ \\ {x}_{m} ( - 1 ) \\ x ( 0 ) \\ x ( 1 ) \\ ⋮ \\ {x}_{m} ( n ) \\ ⋮\end{matrix} ) = ( \begin{matrix}⋮ & & ⋮ & & & & \\ q ( n , {N}_{1} ) & … & q ( n , 1 ) & & & & \\ ⋮ & & ⋮ & & & & \\ q ( 1 , {N}_{1} ) & … & q ( 1 , 1 ) & & & & \\ q ( 0 , {N}_{1} ) & … & q ( 0 , 1 ) & 1 & q ( 0 , 1 ) & … & q ( 0 , {N}_{2} ) \\ & & & & q ( 1 , 1 ) & … & q ( 1 , {N}_{2} ) \\ & & & & ⋮ & & ⋮ \\ & & & & q ( n , 1 ) & … & q ( n , {N}_{2} ) \\ & & & & ⋮ & & ⋮\end{matrix} ) ( \begin{matrix}{x}_{m}^{0} ( - {N}_{1} ) \\ ⋮ \\ {x}_{m}^{0} ( - 1 ) \\ {x}_{m}^{0} ( 0 ) \\ {x}_{m}^{0} ( 1 ) \\ ⋮ \\ {x}_{m}^{0} ( {N}_{2} )\end{matrix} )$$
wherein q columnwise represents the impulse responses of the tapped line of all-pass filters (122_1 . . . 122_L−1).

9. Method for encoding an audio or speech signal s into sinusoidal code data, comprising the steps of:
segmenting said signal s into at least one single scale segment xₘ(n) with m=1 . . . M having the samples xₘ(0), . . . , xₘ(L−1); and
estimating the sinusoidal code data representing said segment xₘ(n) from the received samples xₘ(0), . . . , xₘ(L−1));
characterized in that
a frequency-warping operation is carried out such that the samples xₘ(0), . . . , xₘ(L−1) are provided on a frequency-warped domain; and
said sinusoidal data being estimated on the frequency-warped domain are re-mapped to the original frequency domain of the signal s.
